(19) United States
(12) Patent Application Publication
(10) Pub. No.: US 2023/0001899 A1
(43) Pub. Date: Jan. 5, 2023

(54) SYSTEM ARCHITECTURE OF AN ELECTRONIC BRAKING SYSTEM

(71) Applicant: Knorr-Bremse Systeme Fuer Nutzfahrzeuge GmbH, Muenchen (DE)

(72) Inventors: Wolfgang Gscheidle, Oberstenfeld (DE); Alexander Rammert, Kornwestheim (DE); Friedbert Roether, Cleebronn (DE)

(21) Appl. No.: 17/782,493

(22) PCT Filed: Dec. 8, 2020
(86) PCT No.: PCT/EP2020/085090

§ 371 Date: Jun. 3, 2022

(30) Foreign Application Priority Data
Dec. 16, 2019 (DE) 10 2019 134 466.2

(51) Int. Cl. B60T 8/1766; B60T 13/68

(52) U.S. Cl. CPC B60T 8/1766; B60T 13/686; B60T 2270/10

(57) ABSTRACT

A braking system for a vehicle, including: at least one pressure regulating module to set a setpoint brake pressure for at least one brake cylinder of a vehicle wheel; at least one wheel speed sensor to detect the wheel slip of the one vehicle wheel; at least one pressure control valve, assigned to the brake cylinder of a wheel, to control the brake pressure applied at the brake cylinder depending on the wheel slip; and a central processing unit to control the at least one pressure regulating module and the at least one pressure control valve at least starting from a brake signal and the detected data of the at least one wheel speed sensor, which has a direct connection to the central processing unit to transmit data detected by the wheel speed sensor.

### FIELD OF THE INVENTION

The present invention relates to a refinement of a system architecture of an electronic braking system (EBS) of a motor vehicle, in particular a utility vehicle.

### BACKGROUND INFORMATION

Other EBS systems of a utility vehicle believed to be understood generally have an architecture made up of a central control unit (ECU), at least one pressure regulating module (EPM), which contains pressure regulating valves, and pressure control valves (PCV), which are each assigned to one brake cylinder of a wheel of the vehicle. The braking intention of the driver is detected by a foot brake module and converted there into an electrical signal. Starting from this signal, the ECU calculates, in consideration of further factors, for example, the vehicle mass or the axle load distribution, an optimum setpoint brake pressure which is to be passed on to the respective brake cylinders, which are arranged at the wheels.

The information of the setpoint brake pressure is then passed on as an electrical signal, for example, via a CAN bus to the one or more pressure regulating modules. These are connected to a pressure reservoir container, which provides the reservoir pressure of the system. Starting from the reservoir pressure, the pressure regulating valves of the pressure regulating module are controlled by the control unit so that the pressure regulating module provides the requested setpoint brake pressure to the respective brake cylinders at the wheels.

To prevent slip from existing between wheel and roadway surface during braking (antilock braking system) or acceleration (traction control) of the vehicle wheel, additional pressure control valves can be used, which are arranged between EPM and the respective brake cylinder of the wheel and are controlled by the central control unit.

For this purpose, the slip of the wheels is detected by wheel speed sensors (WSS) in the associated EPMs, wherein the WSS are also assigned to each individual wheel.

If a sensor recognizes slip at a wheel during braking of the vehicle, the ECU instructs the corresponding pressure control valve not to increase or even to reduce the brake pressure applied at the corresponding brake cylinder, in order to brake the wheel less strongly and thus reduce the occurring slip.

In other available EBS systems, one one-channel or two-channel EPM is provided per axle or double axle of the vehicle, which is located in the spatial vicinity of this axle. In multichannel EPMs, different brake pressures can be generated for each channel and conducted to the brake cylinder. The wheel speed sensors for detecting the slip of a wheel are connected here to the corresponding EPM. From there, the items of information are transmitted via the CAN bus connection between pressure regulating module and central control unit to this central control unit.

In simple systems, only one common single-channel pressure regulating module can also be used on one axle, which supplies both wheels of the axle with the same brake pressure. To avoid locking of the wheel having the highest slip in the event of different slips of both wheels of the axle, pressure control valves can be arranged at these wheels in the pneumatic feedline between the pressure regulating module and the brake cylinder, via which the overbraked wheel can be individually regulated. The pressure control valves are always connected here to the central control unit. However, this system architecture has the disadvantage that in the case of a pressure regulating module failing, the wheel speed sensor signals cannot be passed on to the control unit. A failure is to be understood here to mean that the electronic part of the pressure regulating module fails. As a result of this, the ECU will switch off the malfunctioning EPM. The EPM is thus no longer capable of processing the signals transmitted from the ECU and setting the calculated setpoint pressure. Instead, the driver intention is passed on via a pneumatic replacement system to the pressure regulating module and conventional braking is set there using pneumatic control pressure, which is then applied at the brake cylinders.

However, since the wheel speed sensor signals are not transmitted to the control unit in the event of failure of the EPM, ABS control or traction control thus cannot take place. Locking wheels can thus occur during braking actions, due to which the vehicle can swerve in an uncontrollable manner or can lose its steerability, which in turn results in a severe restriction of the safety of the vehicle.

### SUMMARY OF THE INVENTION

It is thus a goal of the present invention to provide a system architecture of the EBS with which controlled operation of the vehicle can still be ensured, even if one or more pressure regulating modules of the vehicle is or are defective. This goal is achieved by the proposed subject matter according to the independent claim. Advantageous refinements of the invention are contained in the dependent claims.

An electronic braking system according to the present invention has a central control unit, which is configured for the purpose, at least starting from a braking signal and the data of at least one wheel speed sensor, of controlling at least one pressure regulating module and at least one pressure control valve. The pressure regulating module is configured here for the purpose, starting from the signal of the central control unit and thus the requested brake pressure, of providing a setpoint brake pressure which is intended to be introduced into at least one brake cylinder of a vehicle wheel. Furthermore, the system has at least one wheel speed sensor, which is assigned to a vehicle wheel and is configured to determine the speed of the wheel. In addition, the system has at least one pressure control valve, which is assigned to the brake cylinder of the at least one wheel and is configured to control the setpoint brake pressure generated by the pressure regulating module in dependence on the wheel slip.

The at least one wheel speed sensor has an electrical connection to the central control unit here, which is configured to transmit data detected in the wheel speed sensor directly. A direct connection thus exists between wheel speed sensor and central control unit. “Direct connection/transmission” is understood in the scope of this application to mean that the data are transmitted via a direct electrical connection without being temporarily stored or processed in a further component of the system.

In one advantageous embodiment of the invention, the central processing unit and the at least one pressure regulating module are arranged in a central unit. In embodiments having more than one pressure regulating module, these are also arranged in the central unit. A central unit is understood in the scope of this application as a structural unit which is provided in such a way that these two components of the system, which form the structural unit of the system, can be installed and removed in one piece. The advantage of an arrangement as a central unit is that for repair or maintenance purposes, the essential components of the EBS can be removed from the vehicle and inserted again. The handling using the system is thus improved and thus the time and cost expenditure for repair and maintenance is reduced.

In a further embodiment based on this configuration, the central control unit and the at least one pressure regulating module only have one housing. The compactness and thus the handling of the system can be further improved in this way and complex and space-occupying housing structures of the individual components can be avoided.

Furthermore, an embodiment of the invention is advantageous in which each wheel of the vehicle to be braked has a separate wheel speed sensor. The slip of each wheel can thus be recognized and the braking of the vehicle can be optimized.

This embodiment is advantageous in particular if in addition each brake cylinder to be controlled of a wheel of the vehicle has a pressure control valve. It can thus be ensured that each wheel can be individually operated at its optimum braking point and the braking can thus be optimized and at the same time the driving dynamics of the vehicle remain controllable at every point in time of the braking.

A further advantageous embodiment of the invention has further sensors in addition to the wheel speed sensors, in particular, for example, sensors for detecting the brake pressure applied at the brake cylinders, which also transmit their recorded data to the control unit via direct transmission. By the brake pressure sensors, it is possible, for example, to check whether the setpoint brake pressure which is set by the pressure regulating module is also actually applied at the brake cylinders, or whether the control unit has to set a higher setpoint brake pressure to achieve the desired braking action. The quality of the braking can thus be further increased by further sensors or inferences can be drawn about the necessity of a repair, due to which the reliability of the braking system can be increased.

In a further advantageous embodiment of the invention, the braking system has a separate brake module for each axle or double axle of the vehicle, which provides the required setpoint brake pressure for the brake cylinders of the respective axle. In this way, it can be ensured that the supply with brake pressure is adapted individually to each axle and the braking performance is thus further improved. It can also be ensured by the use of multiple pressure regulating modules that in the event of a failure of one pressure regulating module, the remaining part of the braking system can still be operated regularly. In this way, the reliability of the braking system can be increased further.

An exemplary embodiment of the invention is described in more detail hereinafter on the basis of the associated figures.

### BRIEF DESCRIPTION OF THE DRAWINGS

FIG. 1 shows a schematic structure of an electronic braking system according to the prior art.

FIG. 2 shows a schematic structure of an embodiment of an electronic braking system according to the invention.

FIG. 3 shows a schematic structure of the embodiment from FIG. 2 in a utility vehicle.

### DETAILED DESCRIPTION

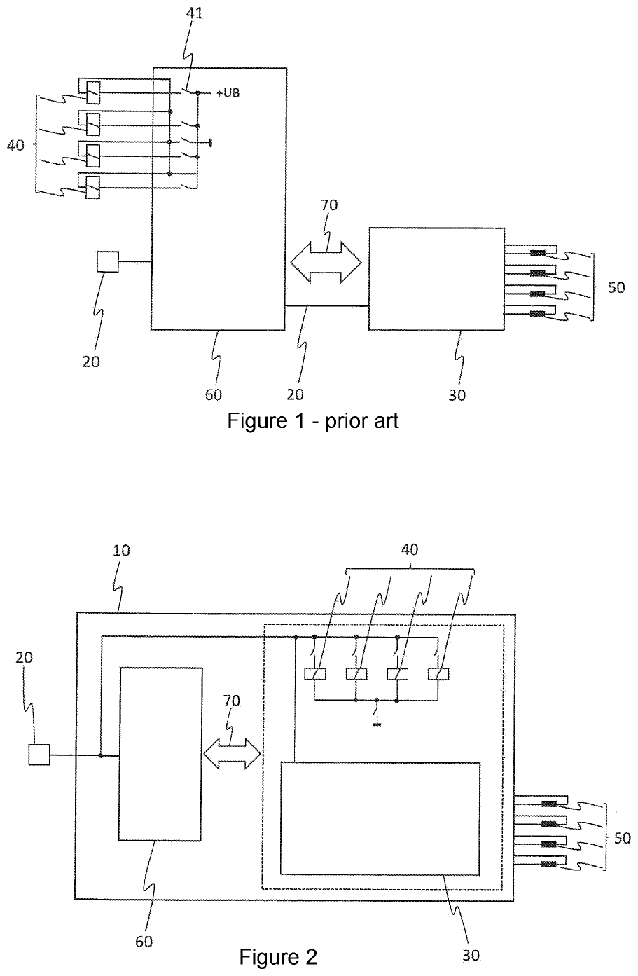

FIG. 1 shows the schematic structure of an electronic braking system according to the prior art.

The control unit 60 is connected to a power supply 20 and controls the four pressure control valves 40, which are each assigned to one wheel of the vehicle, via electronic switches 41. Moreover, the control unit 60 also controls the pressure regulating module 30. The data transmission is ensured here by a CAN bus 70. Of course, other forms of data transmission are also conceivable. The power supply of the pressure regulating module 30 is also ensured via the power supply 20 of the control unit 60. Furthermore, wheel speed sensors 50 detect the speeds of the wheels of the vehicle, wherein each sensor is assigned to one wheel and detects its speed. The wheel speed sensors 50 are not directly connected to the control unit 60 here, but rather communicate via the pressure regulating module 30.

If one of the wheel speed sensors 50 detects slip between a wheel of the vehicle and the roadway during braking of the vehicle, these items of information are conducted to the control unit 60 via the pressure regulating module 30. The pressure control valve 40 corresponding to the wheel at which the slip was established is controlled at the pressure regulating module in such a way that the brake pressure of the relevant brake cylinder 85 is reduced until slip is no longer established by the wheel speed sensor 50 and the traction is established again. An ABS braking action takes place.

A similar functional principle is applied if a wheel speed sensor 50 should establish a slip during the acceleration of the vehicle. In this case, the pressure applied at the corresponding brake cylinder is increased by the central control unit 60 and the spinning wheel is thus braked, so that slip does not occur.

In the event of a failure of the pressure regulating module 30, for example, due to an electrical disturbance, in previous systems, data can no longer be transmitted from the wheel speed sensors 50 to the control unit 60. The control unit 60 therefore also cannot control the pressure control valves 40 so that an ABS braking action or a traction control can take place, which as already described above can have negative effects on the vehicle stability and thus the safety of the vehicle, in particular during braking.

The designation “failure of a pressure regulating module” is understood in the scope of this application to mean that the electronic part of the pressure regulating module 30 fails or, for example, has to be switched off by the ECU due to an occurring defect, so that the control unit 60 can no longer be incorporated in the provision of the brake pressure. Electronic braking systems known from the prior art have a pneumatic replacement system (backup) for this case. The braking intention of the driver is converted here via the existing foot brake module 83 into a pneumatic control pressure, in dependence on which the brake pressure is then generated in the pressure regulating module 30. In this way, a variable brake pressure can still be made available at the brake cylinders 85 of the vehicle, even if the central control unit 60 cannot be incorporated in the control of the brake pressure. However, an ABS braking action or a traction control are no longer possible.

FIG. 2 shows the schematic structure of an embodiment of the electronic braking system according to the invention. The components of the EBS (pressure regulating module 30, pressure control valves 40, central control unit 60) are arranged in a central unit 10 here. Embodiments in which the pressure control valves 40 are arranged outside the braking module 10, but are nonetheless still directly activated by the control unit 60, are also conceivable and typical in practice, however.

In contrast to the system architecture of the EBS shown in FIG. 1, the wheel speed sensors 50 are connected directly to the central unit 10. This is to be understood to mean that due to the direct connection, they are capable of being able to transmit their data directly to the control unit 60, without firstly conducting these data to the pressure regulating module 30, as in the arrangement of FIG. 1. The data of the wheel speed sensors 50 are thus available to the control unit 60 even if the pressure regulating module 30 fails or is switched off. The control unit can thus still intervene in the braking system and an ABS braking action and traction control are thus possible on the basis of the sensor data, which are now available to the control unit 60, via the pressure control valves 40, due to which the braking performance and the controllability of the braking or the traction and the controllability of the vehicle during starting/acceleration and thus the safety of the vehicle can be improved.

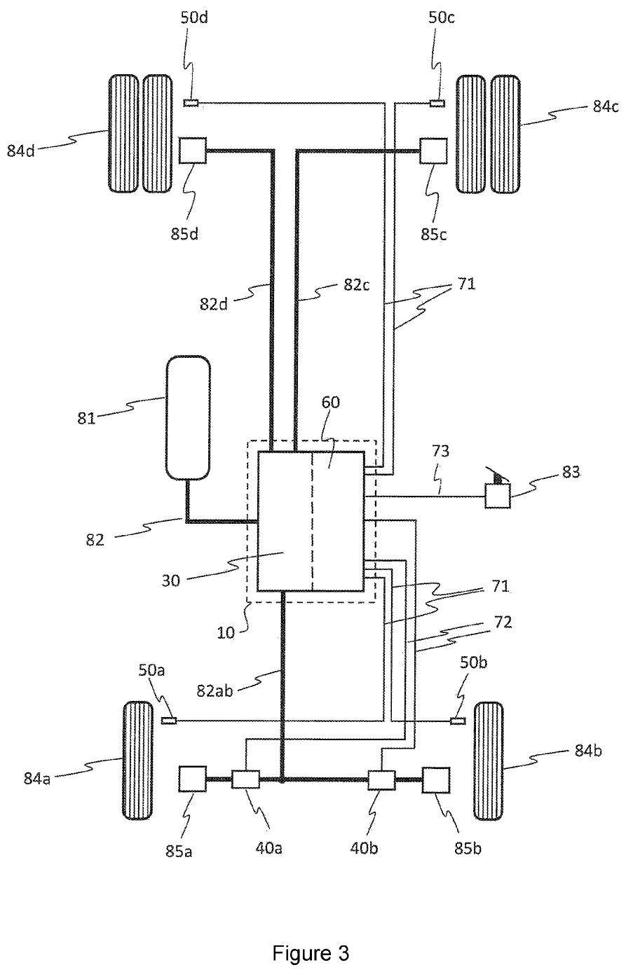

FIG. 3 shows the schematic structure of an embodiment of the system architecture according to the invention of an electronic braking system in a vehicle. The vehicle is a two-axle utility vehicle, which has twin wheels (84c, 84d) on the rear axle. Of course, the application of the invention to a vehicle which does not have twin wheels on the rear axle is also possible.

Each of the wheels (84a, 84b, 84c, 84d) is respectively assigned one brake cylinder (85a, 85b, 85c, 85d) and the front wheels (84a, 84b) are additionally each assigned a pressure control valve (40a, 40b). Moreover, one wheel speed sensor (50a, 50b, 50c, 50d) is respectively located on each wheel (84a, 84b, 84c, 84d), which detects the speed of the corresponding wheel. It is to be noted that the invention is of course not limited to the use of only two pressure control valves, rather embodiments are also possible in which each wheel of the vehicle has a pressure control valve. The pressure control valves (40a, 40b) are located in the pressure line (82ab) between a pressure regulating module 30 and the brake cylinders of the front wheels (84a, 84b), wherein the pressure regulating module 30 is in turn connected to the pressure accumulator 81 via the reservoir line 82. The pressure line 82ab is a single-channel pressure line which transmits the same brake pressure to the brake cylinders 85a and 85b. The pressure lines 82c and 82d are separate pressure lines, by which different brake pressures can be conducted to the brake cylinders 85d or 85c of the rear wheels (84c, 84d), respectively. The pressure regulating module 30 used in the embodiment of FIG. 3 is thus a pressure regulating module having three channels. It is to be noted that in other embodiments multiple individual pressure regulating modules 30 can also be used, for example, one two-channel module for each axle, which can then provide different brake pressures at the brake cylinders of the individual wheels.

Furthermore, the pressure module 30 is located together with the control unit 60 in a central unit 10. Moreover, an electrical connection between the wheel speed sensors (50a, 50b, 50c, 50d) and the control unit 60 exists via the sensor line 71, via which the data acquired by the sensors can be transmitted directly to the control unit 60. The central unit 60 can activate the pressure control valves (40a, 40b) in accordance with the braking requirements and wheel speeds. Moreover, the electronic braking system shown in FIG. 3 has a foot brake module 83, which can transmit items of information to the control unit 60 via a brake line 73.

If the vehicle driver wishes to brake the vehicle, he actuates the foot brake module 83. The actuation is converted there as a function of the actuation intensity into a brake signal and transmitted via the brake line 73 to the control unit 60. The brake signal is used there in consideration of various factors, for example, the vehicle mass or the axle load distribution, to calculate a setpoint brake pressure, which is to be conducted to the brake cylinders (85a, 85b, 85c, 85d) of the four wheels of the vehicle, so that the vehicle decelerates according to the intensity specified by the driver.

Subsequently, the pressure regulating module 30 is controlled by the control unit 60 in such a way that it sets the required setpoint brake pressure. This is then conducted via the pressure lines (82ab, 82c, 82d) to the brake cylinders (85a, 85b, 85c, 85d), by which these are actuated and the vehicle is braked. It is to be noted that embodiments are also conceivable or even advantageous in which a separate setpoint brake pressure is calculated per vehicle axle or even per vehicle wheel, so that each wheel is operated using the respective optimum brake pressure.

The wheel speed sensors (50a, 50b) detect the speeds of the corresponding front wheels (84a, 84b) of the vehicle and transmit them via the sensor line 71 directly to the control unit 60. If this control unit recognizes slip during the braking at a wheel on the basis of the sensor data, it activates the corresponding pressure control valve (40a, 40b) of the respective wheel (84a, 84b) via the activation line 72 to reduce the brake pressure applied at the corresponding brake cylinder (85a, 85b), until slip is no longer recognized, to thus carry out ABS braking. If slip is recognized during the acceleration process, the traction control is carried out as described above with respect to FIG. 1.

In the illustrated system architecture according to the invention it is thus possible due to the wheel speed sensors (50a, 50b, 50c, 50d) connected directly to the ECU 60 to carry out ABS braking or traction control at the control unit 60, even if the pressure regulating module 30 has failed and can no longer communicate with the control unit 60.

### THE LIST OF REFERENCE SIGNS IS AS FOLLOWS

10 central unit

20 power supply

30 pressure regulating module (EPM)

40, 40a, 40b pressure control valve (PCV)

41 switch

50, 50a, 50b, 50c, 50d wheel speed sensor (WSS)

60 control unit (ECU)

70 data transmission line (for example, CAN)

71 sensor line

72 activation line (PCVs)

73 brake line

80 vehicle

81 pressure reservoir container

82 reservoir line

82ab pressure line (EPM to brake cylinders of the front axle)

82c, 82d pressure line (EPM to brake cylinders of the rear axle)

83 foot brake module

84a, 84b vehicle wheel at front axle

84c, 84d vehicle wheel at rear axle

85a, 85b, 85c, 85d brake cylinder

1-7. (canceled)

8. A braking system for a vehicle, comprising:
at least one pressure regulating module to set a setpoint brake pressure to be introduced into at least one brake cylinder of a wheel of the vehicle;
at least one wheel speed sensor to detect the wheel slip of the one wheel of the vehicle;
at least one pressure control valve, which is assigned to the brake cylinder of a wheel, to control the brake pressure applied at the brake cylinder in dependence on the wheel slip; and
a central processing unit to control the at least one pressure regulating module and the at least one pressure control valve at least starting from a brake signal and the detected data of the at least one wheel speed sensor;
wherein the at least one wheel speed sensor has a direct connection to the central processing unit to transmit data detected by the wheel speed sensor.

9. The braking system of claim 8, wherein the central processing unit and the at least one pressure regulating module are arranged in a central unit.

10. The braking system of claim 9, wherein the central processing unit and the at least one pressure regulating module have a common housing.

11. The braking system of claim 8, wherein the braking system has a wheel speed sensor for each wheel to be braked of the vehicle.

12. The braking system of claim 8, wherein the braking system has a pressure control valve for each brake cylinder to be controlled of a wheel of the vehicle.

13. The braking system of claim 8, wherein the braking system has at least one further sensor, which is a sensor for detecting the brake pressure, wherein the at least one further sensor also has a connection to the central processing unit, which is configured to transmit data directly.

14. The braking system of claim 8, wherein the braking system has multiple pressure regulating modules and at least one pressure regulating module for each axle or for each double axle of the vehicle.
